(19) United States
(12) Patent Application Publication
(10) Pub. No.: US 2014/0376255 A1
(43) Pub. Date: Dec. 25, 2014

(54) DISPLAY

(71) Applicant: Au Optronics Corporation, Hsinchu (TW)

(72) Inventors: Kuei-Bai Chen, New Taipei City (TW); Chia-Hao Li, Taoyuan County (TW); Chen-Hsien Liao, Taipei City (TW)

(73) Assignee: Au Optronics Corporation, Hsinchu (TW)

(21) Appl. No.: 14/013,038

(22) Filed: Aug. 29, 2013

(30) Foreign Application Priority Data
Jun. 20, 2013 (TW) 102122123

(51) Int. Cl. F21K 99/00; F21V 33/00

(52) U.S. Cl. CPC F21K 9/52; F21V 33/0052
USPC 362/606; 362/97.1

(57) ABSTRACT

A display including a backlight module, a display panel, and a color filter layer is provided. The backlight module includes a light source having a luminescence spectrum with three protrusions. Peaks of the protrusions fall in different ranges and full width at half maximum (FWHM) of each of the peaks are in respective ranges. The display panel is disposed on the backlight module. The color filter layer disposed on the backlight module includes three color filtering patterns. Peaks of transmission spectra of the color filtering patterns respectively overlap the FWHM ranges of the three protrusions.

### CROSS-REFERENCE TO RELATED APPLICATION

This application claims the priority benefit of Taiwan application serial no. 102122123, filed on Jun. 20, 2013. The entirety of the above-mentioned patent application is hereby incorporated by reference herein and made a part of this specification.

### BACKGROUND OF THE INVENTION

1. Field of the Invention

The present invention generally relates to a display, and more particularly, to a display of high National Television System Committee (NTSC) color saturation.

2. Description of Related Art

With the development of the Internet and the radio communications technology, portable information products, such as notebook computers, mobile phones, digital cameras, and personal digital assistants (PDA), have been quickly developed and widely spread. Liquid crystal display (LCD) offers many advantages, such as slim appearance, light weight, low power consumption, zero radioactive contamination, and high compatibility to semiconductor manufacturing technology, therefore has been applied to many earlier low-information-quantity display products (for example, watches and calculators) and has been gradually spread to fine monitors and portable information products.

The National Television System Committee (NTSC) color space is a standard used for evaluating the color performance of a display. Based on this standard, a display manufacturer can define the color rendering ability of a display. For example, 75% NTSC marked on a typical LCD indicates that the LCD possesses a color rendering ability of 75% of the NTSC color space. The NTSC color performances of existing displays usually fall within the range of 72%-80%.

### SUMMARY OF THE INVENTION

Accordingly, the present invention is directed to a display whose National Television System Committee (NTSC) color saturation is greater than 96%.

The present invention provides a display including a backlight module, a display panel, and a color filter layer. The backlight module includes a light source, and a luminescence spectrum of the light source has a first protrusion, a second protrusion, and a third protrusion. A peak of the first protrusion falls in the range of 447 nm to 451 nm, and a full width at half maximum (FWHM) of the first protrusion falls in the range of 20 nm to 25 nm. A peak of the second protrusion falls in the range of 529 nm to 533 nm, and a FWHM of the second protrusion falls in the range of 72 nm to 76 nm. A peak of the third protrusion falls in the range of 642 nm to 644 nm, and a FWHM of the third protrusion falls in the range of 80 nm to 86 nm. The display panel is disposed on the backlight module. The color filter layer is disposed on the backlight module. The color filter layer includes at least one first color filtering pattern, at least one second color filtering pattern, and at least one third color filtering pattern. A peak of a transmission spectrum of the first color filtering pattern overlaps the FWHM range of the first protrusion, a peak of a transmission spectrum of the second color filtering pattern overlaps the FWHM range of the second protrusion, and a peak of a transmission spectrum of the third color filtering pattern overlaps the FWHM range of the third protrusion.

As described above, in a display provided by the present invention, the transmission spectrum of a color filter layer and the luminescence spectrum of a light source in a backlight module are appropriately combined, and meanwhile, the luminous intensity of the light source in the backlight module is adjusted, so that the NTSC color saturation of the display is increased to at least 96%.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a display according to an embodiment of the present invention.

FIG. 2 is a diagram of a single light emitting diode (LED).

FIG. 3 is a graph illustrating the relationship between the wavelength and light transmission intensity of a color filter layer.

FIG. 4A is a graph illustrating color light wavelengths and color light intensities of samples 1-12.

FIG. 4B is a graph illustrating color light wavelengths and color light intensities of samples 13-15.

FIG. 4C is a graph illustrating color light wavelengths and color light intensities of a sample 6.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Since the National Television System Committee (NTSC) color saturation of existing displays cannot not meet users' requirement to the color performance of a display, the present invention provides a display whose NTSC color saturation can reach up to 96%, as described in following embodiment.

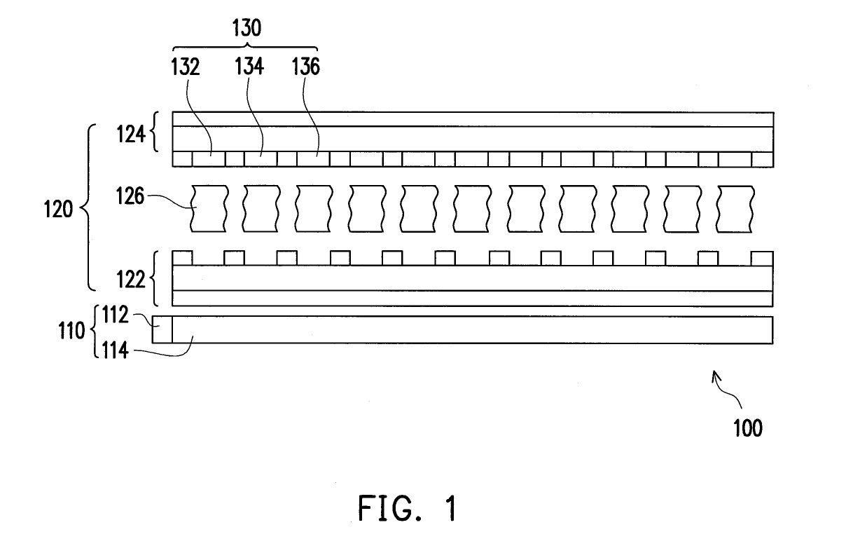

FIG. 1 is a diagram of a display according to an embodiment of the present invention. Referring to FIG. 1, the display 100 includes a backlight module 110, a display panel 120, and a color filter layer 130. The backlight module 110 includes a light source 112. The display panel 120 is disposed on the backlight module 110, and the color filter layer 130 is also disposed on the backlight module 110.

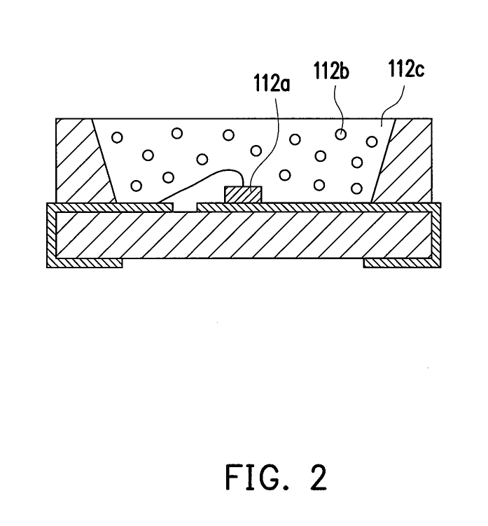

To be specific, the light source 112 is a light emitting diode (LED) light source. A single LED is illustrated in FIG. 2. The LED light source includes a light emitting chip 112a and a phosphor 112b. The phosphor 112b is a sulphide phosphor. The photoluminescence spectrum of the phosphor 112b is different from the luminescence spectrum of the light emitting chip 112a. The phosphor 112b is distributed around the light emitting chip 112a by being doped in a transparent material 112c that covers the light emitting chip 112a. Generally, the light emitting chip 112a is a blue light chip, and the transparent material 112c is silicon. The blue light emitted by the blue light chip excites the phosphor 112b to produce a yellow light, and a white light is produced when the yellow light and the blue light are combined. Thus, the light source 112 emits a white light. However, the present invention is not limited thereto. In the present embodiment, the phosphor 112b is a mixture of red light phosphor and green light phosphor, where the concentration ratio, volume, and distributed position in the transparent material 112c of the red light phosphor and the green light phosphor affect the color uniformity and luminous efficiency of the backlight module 110.

The display 100 may be a direct backlight module or a lateral backlight module according to the actual requirement. In a display 100 with a direct backlight module, the light source 112 of the backlight module is disposed below the display panel 120, and no additional device for changing light transmission path is disposed between the light source 112 of the backlight module and the display panel 120. In short, the light emitted by the backlight module 110 enters the display panel 120 directly. In a display 100 with a lateral backlight module, the backlight module 110 further includes a light guide plate 114, the light source 112 is disposed at a first side of the light guide plate 114, and the display panel 120 is disposed at a second side of the light guide plate 114, where the first side and the second side are adjacent to each other. In the display 100 with a lateral backlight module 110, the light source 112 is not disposed directly below the display panel 120, and the light source 112 faces the light guide plate 114 to emit light, so that the light guide plate 114 can guide the light to allow the light to enter the display panel 120. In the present embodiment, the backlight module 110 of the display 100 is a lateral backlight module.

Referring to FIG. 1 again, the display panel 120 in the present embodiment includes a first substrate 122, a second substrate 124, and a display medium 126 disposed between the first substrate 122 and the second substrate 124. The first substrate 122 is an active device array substrate, the second substrate 124 is an opposite substrate, and the display medium 126 is one or a combination of a liquid crystal layer, an electrowetting display medium, and an electrophoretic display medium. The color filter layer 130 is disposed between the first substrate 122 and the second substrate 124 and is disposed on the first substrate 122 or the second substrate 124 according to the actual requirement. In the present invention, the disposed position of the color filter layer 130 is not limited, and any design which allows the display light to pass through the display medium 126 and the color filter layer 130 before exiting the display panel 120 can be considered as an implementation of the present invention.

The color filter layer 130 includes at least one first color filtering pattern 132, at least one second color filtering pattern 134, and at least one third color filtering pattern 136. The first color filtering pattern 132 may be a blue color (B) filtering pattern, the second color filtering pattern 134 may be a green color (G) filtering pattern, and the third color filtering pattern 136 may be a red color (R) filtering pattern.

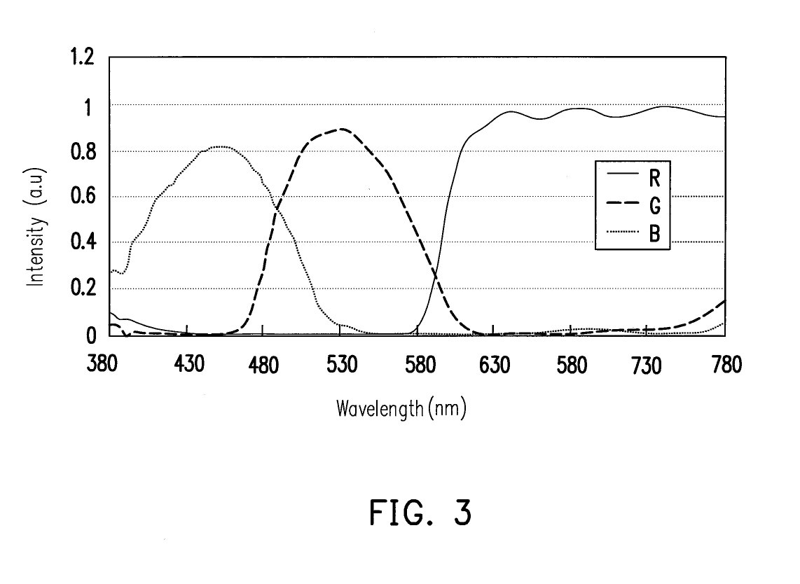

FIG. 3 is a graph illustrating the relationship between the wavelength and light transmission intensity of a color filter layer. Referring to both FIG. 1 and FIG. 3, in the present embodiment, the peak of the transmission spectrum of the first color filtering pattern 132 falls in the range of 452 nm to 456 nm, and the full width at half maximum (FWHM) of the transmission spectrum of the first color filtering pattern 132 falls in the range of 88 nm to 92 nm. For example, the material of the first color filtering pattern 132 includes a phthalocyanine compound (for example, a dye of number B15:6) expressed as following expression (1) and a xanthene compound or a metal complex (for example, a purple dye) expressed as following expression (2), where the weight percentage of the B15:6 dye is about 0.4-0.5, and the weight percentage of the purple dye is about 0.6-0.5.

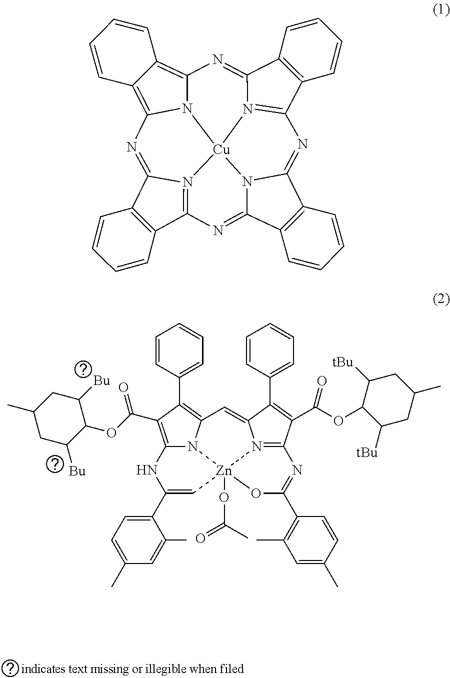

The peak of the transmission spectrum of the second color filtering pattern 134 falls in the range of 528 nm to 532 nm, and the FWHM of the transmission spectrum of the second color filtering pattern 134 falls in the range of 96 nm to 100 nm. For example, the material of the second color filtering pattern 134 includes a halogen-phthalocyanine compound (for example, a dye of number G58) expressed as following expression (3) and an azo compound (for example, a dye of number Y150) expressed as following expression (4), where the weight percentage of the G58 dye is about 0.7-0.8, and the weight percentage of the Y150 dye is about 0.3-0.2.

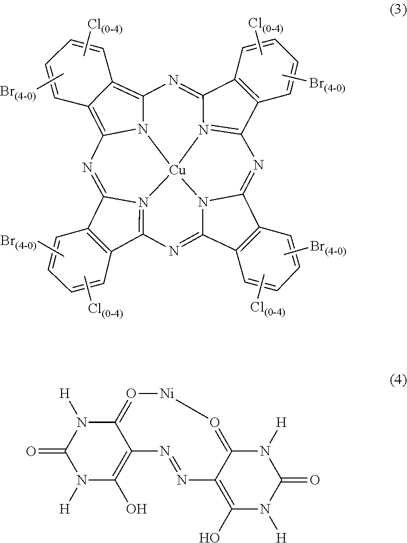

The peak of the transmission spectrum of the third color filtering pattern 136 falls in the range of 725 nm to 780 nm, and the peak intensity of the transmission spectrum of the third color filtering pattern 136 falls in the range of 0.94 to 0.99. For example, the material of the third color filtering pattern 136 includes a DPP compound (for example, a dye of number R254) expressed as following expression (5) and an anthraquinone compound (for example, a dye of number R177) expressed as following expression (6), where the weight percentage of the R254 dye is about 0.52-0.58, and the weight percentage of the R177 dye is about 0.42-0.48.

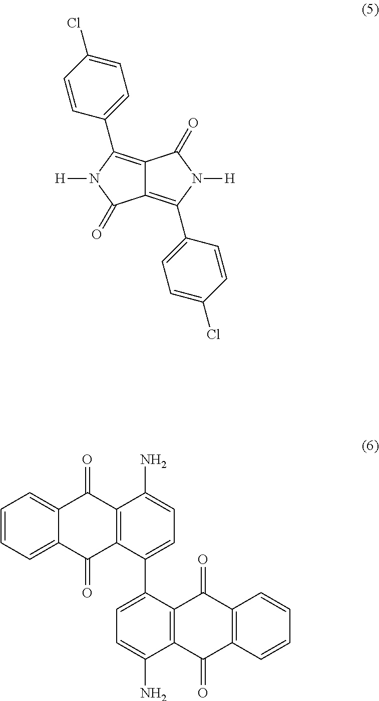 [SMILES: O=C1NC(c2ccc(Cl)cc2)=C2C(=O)NC(c3ccc(Cl)cc3)=C12 ; Nc1ccc(-c2ccc(N)c3c2C(=O)c2ccccc2C3=O)c2c1C(=O)c1ccccc1C2=O]

Aforementioned dyes can be mixed in different proportions to allow the color filtering patterns 132, 134, and 136 to have different colorimetric shifts. Namely, the materials and the proportions of different materials of each color filtering pattern 132, 134, or 136 are not limited to foregoing examples.

Generally, the display medium 126 of the display 100 does not emit light itself For example, when the material of the display medium 126 is a liquid crystal material, an electrowetting medium, or an electrophoretic material, the luminescence spectrum of the light source 112 of the display 100 and the transmission spectrum of the color filter layer 130 determine the display color of the display 100. Below, the display color of the display 100 is experimented with some samples designed according to the structure of the display 100, where the same color filter layer 130 but different light sources 112 are adopted with the samples 1-15. It should be mentioned that the color filter layer 130 disposed in the samples 1-15 satisfies the conditions described above therefore will not be described herein.

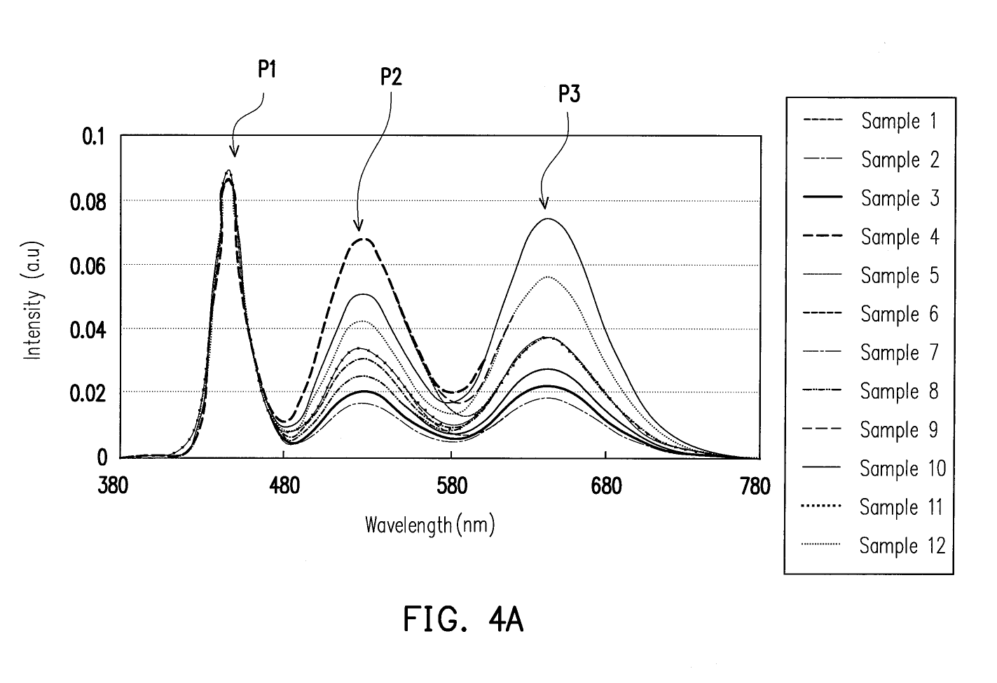

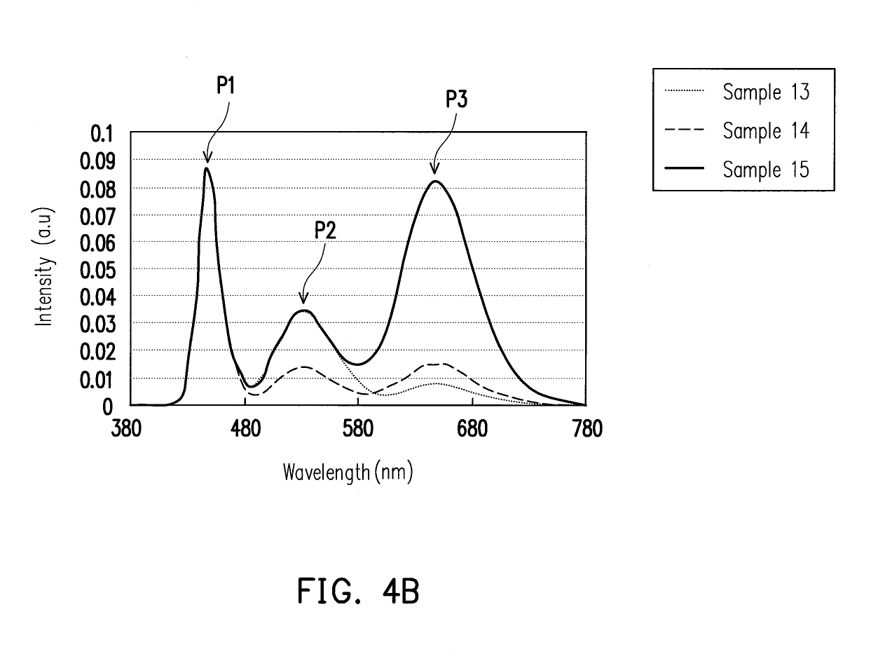

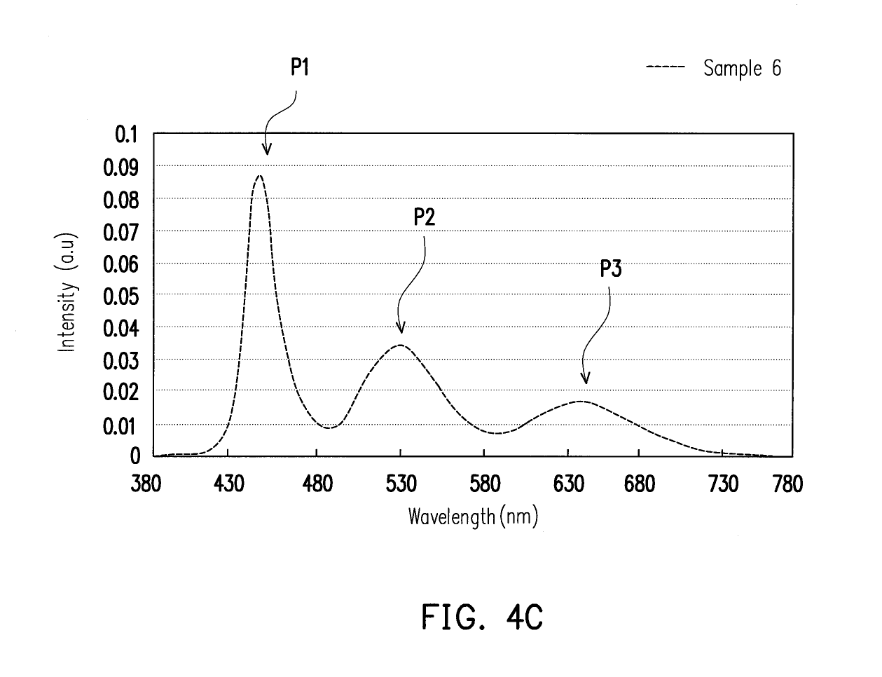

FIG. 4A illustrates the luminescence spectrum of the light source used by samples 1-12 (i.e., the relationship between the wavelength and light emission intensity of the light source), and FIG. 4B illustrates the luminescence spectrum of the light source used by samples 13-15 (i.e., the relationship between the wavelength and light emission intensity of the light source). Referring to FIG. 4A and FIG. 4B, in the present embodiment, the luminescence spectrum of the light source 112 has a first protrusion P1, a second protrusion P2, and a third protrusion P3. The first protrusion P1, the second protrusion P2, and the third protrusion P3 are respectively corresponding to the wavelength ranges of the blue light, the green light, and the red light. In the present embodiment, the peak of the first protrusion P1 falls in the range of 447 nm to 451 nm, and the FWHM of the first protrusion P1 falls in the range of 20 nm to 25 nm, the peak of the second protrusion P2 falls in the range of 529 nm to 533 nm, and the FWHM of the second protrusion P2 falls in the range of 72 nm to 76 nm, and the peak of the third protrusion P3 falls in the range of 642 nm to 644 nm, and the FWHM of the third protrusion falls in the range of 80 nm to 86 nm.

In addition, the peak ratios of red light (R), green light (G), and blue light (B) emitted by the light source 112 in the samples 1-15 are listed in following table 1, where the luminescence spectrum of the sample 6 (as shown in FIG. 4C) is served as a reference compared to the peak ratios in other samples. In the samples 1-15, the blue light is emitted by the light emitting chip 112a of the light source 112, and accordingly the blue light peaks in all the samples 1-15 are identical. The peaks of the red light and the green light vary with different concentration proportions of red color phosphor and green color phosphor. Moreover, the last two fields in following table 1 contains the coordinates of the white light emitted by the light source 112 in the CIE 1931 color coordinate system.

TABLE 1

| | Peak Ratios | | | | |
|---|---|---|---|---|---|
| | | Green | | White Light | |
| | Blue Light | Light | Red Light | X-coordinate | Y-coordinate |
| Sample 1 | 1 | 1 | 0.5 | 0.244 | 0.262 |
| Sample 2 | 1 | 0.5 | 0.5 | 0.241 | 0.184 |
| Sample 3 | 1 | 0.6 | 0.6 | 0.252 | 0.205 |
| Sample 4 | 1 | 0.75 | 0.75 | 0.266 | 0.232 |
| Sample 5 | 1 | 2 | 1 | 0.279 | 0.358 |
| Sample 6 | 1 | 1 | 1 | 0.285 | 0.267 |
| Sample 7 | 1 | 0.9 | 1 | 0.286 | 0.256 |
| Sample 8 | 1 | 0.75 | 1 | 0.287 | 0.236 |
| Sample 9 | 1 | 2 | 1.5 | 0.307 | 0.355 |
| Sample | 1 | 1.25 | 1.5 | 0.316 | 0.297 |
| 10 | | | | | |
| Sample | 1 | 2 | 2 | 0.331 | 0.353 |
| 11 | | | | | |
| Sample | 1 | 1.6 | 2 | 0.338 | 0.319 |
| 12 | | | | | |
| Sample | 1 | 1 | 0.2 | 0.214 | 0.258 |
| 13 | | | | | |
| Sample | 1 | 0.4 | 0.4 | 0.228 | 0.16 |
| 14 | | | | | |
| Sample | 1 | 1 | 0.2 | 0.358 | 0.278 |
| 15 | | | | | |

TABLE 2

| Full Cell | R | | | G | | | B | | | W | | | | | | |
|---|---|---|---|---|---|---|---|---|---|---|---|---|---|---|---|---|
| SIMULATION | x | y | Y | x | y | Y | x | y | Y | x | y | Y | NTSC % | sRGB | EBU | Adobe |
| Sample 1 | 0.676 | 0.305 | 1.90 | 0.236 | 0.683 | 13.30 | 0.150 | 0.049 | 1.49 | 0.238 | 0.299 | 5.56 | 98.37 | 100.0% | 100.0% | 93.4% |
| Sample 2 | 0.679 | 0.302 | 3.08 | 0.241 | 0.662 | 11.51 | 0.152 | 0.036 | 1.80 | 0.242 | 0.212 | 5.47 | 96.79 | 99.9% | 99.9% | 88.9% |
| Sample 3 | 0.681 | 0.303 | 3.12 | 0.242 | 0.667 | 11.66 | 0.152 | 0.039 | 1.65 | 0.252 | 0.234 | 5.48 | 97.55 | 99.9% | 99.9% | 89.9% |
| Sample 4 | 0.683 | 0.304 | 3.16 | 0.243 | 0.672 | 11.81 | 0.151 | 0.043 | 1.49 | 0.265 | 0.263 | 5.49 | 98.16 | 100.0% | 99.9% | 90.8% |
| Sample 5 | 0.682 | 0.309 | 1.94 | 0.237 | 0.691 | 13.60 | 0.147 | 0.074 | 1.20 | 0.269 | 0.396 | 5.58 | 97.66 | 99.1% | 99.1% | 94.1% |
| Sample 6 | 0.685 | 0.305 | 3.20 | 0.244 | 0.677 | 11.96 | 0.151 | 0.049 | 1.32 | 0.283 | 0.300 | 5.50 | 98.43 | 100.0% | 100.0% | 91.5% |
| Sample 7 | 0.685 | 0.305 | 3.44 | 0.245 | 0.674 | 11.65 | 0.151 | 0.047 | 1.35 | 0.285 | 0.287 | 5.48 | 98.25 | 100.0% | 100.0% | 90.9% |
| Sample 8 | 0.686 | 0.304 | 3.87 | 0.248 | 0.669 | 11.09 | 0.152 | 0.043 | 1.39 | 0.288 | 0.266 | 5.45 | 97.64 | 99.9% | 99.9% | 89.7% |
| Sample 9 | 0.686 | 0.307 | 2.65 | 0.242 | 0.688 | 12.85 | 0.147 | 0.074 | 1.13 | 0.298 | 0.390 | 5.54 | 97.58 | 99.2% | 99.2% | 93.1% |
| Sample 10 | 0.688 | 0.306 | 3.68 | 0.248 | 0.678 | 11.59 | 0.150 | 0.056 | 1.17 | 0.313 | 0.328 | 5.48 | 97.94 | 100.0% | 100.0% | 91.1% |
| Sample 11 | 0.688 | 0.307 | 3.27 | 0.245 | 0.685 | 12.19 | 0.148 | 0.074 | 1.07 | 0.323 | 0.385 | 5.51 | 97.10 | 99.2% | 99.2% | 92.1% |
| Sample 12 | 0.689 | 0.306 | 3.97 | 0.250 | 0.679 | 11.36 | 0.150 | 0.063 | 1.08 | 0.335 | 0.349 | 5.47 | 97.25 | 100.0% | 100.0% | 90.9% |
| Sample 13 | 0.652 | 0.306 | 0.94 | 0.231 | 0.687 | 14.29 | 0.149 | 0.049 | 1.60 | 0.207 | 0.297 | 5.61 | 94.74 | 99.4% | 99.5% | 92.5% |
| Sample 14 | 0.676 | 0.300 | 3.02 | 0.239 | 0.655 | 11.30 | 0.152 | 0.033 | 2.03 | 0.229 | 0.186 | 5.45 | 95.53 | 99.9% | 99.9% | 87.2% |
| Sample 15 | 0.690 | 0.305 | 5.38 | 0.261 | 0.664 | 9.73 | 0.152 | 0.050 | 1.06 | 0.360 | 0.303 | 5.39 | 95.63 | 99.9% | 99.9% | 87.3% |

Foregoing table 2 shows the color performance of the display 100 after the light source 112 and the color filter layer 130 are combined. The coordinates of the red light (R), green light (G), blue light (B), and white light (W) in the CIE 1931 color coordinate system are also listed in table 2. It can be observed in table 2 that the NTSC color saturation of the display 100 in the samples 1-12 is at least 96%. It can also be understood by referring to foregoing table 2 that the NTSC color saturation of the display 100 in the samples 13-15 is lower than 96%.

Thereby, based on foregoing table 1 and table 2, the display 100 can achieve an ideal color saturation when the light source 112 adopts the designs of the samples 1-12. In particular, with the design of sample 6, the green light (G) peak ratio and the red light (R) peak ratio of the light source 112 are preferably greater than or equal to 0.5 and smaller than or equal to 2. Thus, the X-coordinate of the white light emitted by the light source 112 in the CIE 1931 color coordinate system falls in the range of 0.241 to 0.338, and the Y-coordinate thereof falls in the range of 0.184 to 0.358. Besides, the NTSC color saturation of the display 100 is at least 96%.

It can be understood based on the samples 13-15 that when the intensity of one of the green light (G) and the red light (R) is smaller than 0.5 or greater than 2, the X-coordinate of the white light (W) in the CIE 1931 color coordinate system falls out of the range of 0.241 to 0.338, and the Y-coordinate thereof also falls out of the range of 0.184 to 0.358. In this case, the NTSC color saturation of the display 100 is lower than 96%, which does not meet the users' or designers' requirement of high color saturation to the display 100.

As described above, in a display provided by the present invention, the luminescence spectrum of the light source is appropriately designed, the peak of the transmission spectrum of each color filtering pattern is overlapped with the FWHM of a corresponding protrusion in the luminescence spectrum of the light source, and the intensity of each color light in the light source is adjusted, so that the NTSC color saturation of the display can be increased to at least 96% to meet user's or designers' requirement of high color saturation to the display.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display, comprising:
a backlight module, comprising a light source, wherein a luminescence spectrum of the light source has a first protrusion, a second protrusion, and a third protrusion, a peak of the first protrusion falls in the range of 447 nm to 451 nm, and a full width at half maximum (FWHM) of the first protrusion falls in the range of 20 nm to 25 nm, a peak of the second protrusion falls in the range of 529 nm to 533 nm, and a FWHM of the second protrusion falls in the range of 72 nm to 76 nm, and a peak of the third protrusion falls in the range of 642 nm to 644 nm, and a FWHM of the third protrusion falls in the range of 80 nm to 86 nm;
a display panel, disposed on the backlight module; and
a color filter layer, disposed on the backlight module, and comprising at least one first color filtering pattern, at least one second color filtering pattern, and at least one third color filtering pattern, wherein a peak of a transmission spectrum of the first color filtering pattern overlaps a FWHM range of the first protrusion, a peak of a transmission spectrum of the second color filtering pattern overlaps a FWHM range of the second protrusion, and a peak of a transmission spectrum of the third color filtering pattern overlaps a FWHM range of the third protrusion.

2. The display according to claim 1, wherein the peak of the transmission spectrum of the first color filtering pattern falls in the range of 452 nm to 456 nm, the peak of the transmission spectrum of the second color filtering pattern falls in the range of 528 nm to 532 nm, and the peak of the transmission spectrum of the third color filtering pattern falls in the range of 725 nm to 780 nm.

3. The display according to claim 2, wherein a FWHM of the transmission spectrum of the first color filtering pattern falls in the range of 88 nm to 92 nm.

4. The display according to claim 2, wherein a FWHM of the transmission spectrum of the second color filtering pattern falls in the range of 96 nm to 100 nm.

5. The display according to claim 2, wherein a peak intensity of the transmission spectrum of the third color filtering pattern is 0.94 to 0.99.

6. The display according to claim 1, wherein the light source of the backlight module comprises a light emitting diode (LED) light source.

7. The display according to claim 6, wherein the LED light source comprises a light emitting chip and a phosphor, the phosphor is distributed around the light emitting chip, and a photoluminescence spectrum of the phosphor is different from a luminescence spectrum of the light emitting chip.

8. The display according to claim 7, wherein the phosphor is sulphide phosphor.

9. The display according to claim 6, wherein the backlight module further comprises a light guide plate, the light source is disposed at a first side of the light guide plate, the display panel is disposed at a second side of the light guide plate, and the first side and the second side are adjacent to each other.

10. The display according to claim 1, wherein the light source of the backlight module emits a white light, an X-coordinate of the white light in a CIE 1931 color coordinate system is between 0.241 and 0.338, and a Y-coordinate of the white light in the CIE 1931 color coordinate system is between 0.184 and 0.358.

11. The display according to claim 1, wherein the display panel comprises a first substrate, a second substrate, and a display medium, and the display medium is disposed between the first substrate and the second substrate.

12. The display according to claim 11, wherein the color filter layer is disposed between the first substrate and the second substrate.

13. The display according to claim 11, wherein the display medium comprises one or a combination of a liquid crystal layer, an electrowetting display medium, and an electrophoretic display medium.

14. The display according to claim 1, wherein a National Television System Committee (NTSC) color saturation of the display is greater than 96%.

15. The display according to claim 1, wherein the light source of the backlight module emits a blue light, a green light, and a red light, a peak ratio of the green light is between 0.5 and 2, and a peak ratio of the red light is between 0.5 and 2.
